(19) United States
(12) Patent Application Publication
(10) Pub. No.: US 2023/0351431 A1
(43) Pub. Date: Nov. 2, 2023

(54) System, Method, and Computer Program Product for Segmenting Users Using a Machine Learning Model Based on Transaction Data

(71) Applicant: Visa International Service Association, San Francisco, CA (US)

(72) Inventors: Patrycja Marzena Sawicka, Warsaw (PL); Magdalena Zieleniewska, Warsaw (PL); Anna Rekus, Warsaw (PL); Elsa Meserlian, Newport Pagnell (GB)

(21) Appl. No.: 17/731,819

(22) Filed: Apr. 28, 2022

(51) Int. Cl. G06Q 30/02; G06K 9/62

(52) U.S. Cl. CPC G06Q 30/0224; G06Q 30/0239; G06K 9/6223; G06N 20/00

(57) ABSTRACT

A method, system, and computer program product is provided for segmenting users using a machine learning model based on transaction data. The method includes receiving survey data and historical transaction data for a first subset of users and segmenting each of the first subset of users into at least one group, where each group may be associated with at least one characteristic. The historical transaction data for the first subset of users may be analyzed against the survey data and/or the at least one characteristic to associate at least one transaction parameter with each group. Historical transaction data for a second subset of users may be received and the second subset of users may be segmented, using a machine learning model, into at least one group. A targeted communication may be transmitted to each of the second subset of users in the group.

### BACKGROUND

### 1. Field

This disclosure relates generally to machine learning models and, in some non-limiting embodiments or aspects, systems, methods, and computer program products for segmenting users using a machine learning model based on transaction data.

### 2. Technical Considerations

Machine learning may refer to a field of computer science that uses statistical techniques to provide a computer system with the ability to learn (e.g., progressively improve performance of) a task with a given dataset, without the computer system being programmed to perform the task. In some instances, a machine learning model may use clustering algorithms to segment individuals based on survey data.

Currently, survey data may be used to create personas based on sets of questions and corresponding responses. The survey data may be used to access the effectiveness of targeted campaigns (e.g., a marketing campaign). Current methods require individuals to complete and submit surveys. The individuals may be segmented into groups related to personas based on their responses to the questions. In some instances, the sets of questions may be related to an individual's general lifestyle and personality. This approach is based on subjective statements which may not accurately reflect an individual's real-life actions because the responses are not linked directly to an individual's actions (e.g., transaction behavior).

### SUMMARY

Accordingly, disclosed are systems, devices, products, apparatus, and/or methods for segmenting users using a machine learning model based on transaction data.

According to some non-limiting embodiments or aspects, provided is a computer-implemented method for segmenting users using a machine learning model based on transaction data. The method includes receiving survey data and historical transaction data for a first subset of users, wherein for each user of the first subset of users, the survey data comprises a plurality of questions and a plurality of responses to the plurality of questions, and the historical transaction data comprises a plurality of transaction parameters associated with electronic payment transactions engaged in by a user of the first subset of users. The method further includes, based on the survey data, segmenting each user of the first subset of users into at least one group of a plurality of groups, wherein each group of the plurality of groups is associated with at least one characteristic. The method further includes analyzing the historical transaction data for the first subset of users against the survey data and/or the at least one characteristic to associate at least one transaction parameter of the plurality of transaction parameters with each group of the plurality of groups; receiving data for a second subset of users, the second subset of users does not contain users from the first subset of users, the data comprises historical transaction data for the second subset of users. The method further includes based on the historical transaction data for the second subset of users, segmenting, with a first machine learning model, each user of the second subset of users into at least one group of the plurality of groups. The method further includes, based on at least one characteristic associated with the at least one group of the plurality of groups, automatically transmitting a targeted communication to each user of the second subset of users in the at least one group.

In some non-limiting embodiments or aspects, the method further includes generating the first machine learning model, wherein generating the first machine learning model comprises training the first machine learning model to perform a first task, the first task comprises segmenting each user of the second subset of users into at least one group of the plurality of groups based on inputting the historical transaction data for the second subset of users into the first machine learning model and based on the association of the at least one transaction parameter of the plurality of transaction parameters with each group of the plurality of groups.

In some non-limiting embodiments or aspects, the method further includes determining a plurality of characteristics based on the plurality of responses to the plurality of questions. In some non-limiting embodiments or aspects, the method further includes, segmenting users from the first subset of users into the plurality of groups based on the plurality of characteristics, wherein each group of the plurality of groups is associated with at least one characteristic of the plurality of characteristics.

In some non-limiting embodiments or aspects, when segmenting each user of the first subset of users into at least one group of the plurality of groups comprises, the method further includes analyzing the plurality of responses to the plurality of questions for each user of the first subset of users; determining at least one characteristic for each user of the first subset of users based on a respective plurality of responses to the plurality of questions for each user of the first subset of users; and segmenting each user of the first subset of users into at least one group of the plurality of groups based on the determined at least one characteristic for each user of the first subset of users.

In some non-limiting embodiments or aspects, when analyzing the historical transaction data for the first subset of users against the survey data and/or the at least one characteristic to associate at least one transaction parameter of the plurality of transaction parameters with each group of the plurality of groups, the method further includes automatically analyzing the historical transaction data for the first subset of users against the survey data and/or the at least one characteristic to associate at least one transaction parameter of the plurality of transaction parameters with each group of the plurality of groups using a second machine learning model.

In some non-limiting embodiments or aspects, when automatically transmitting the targeted communication to each user of the second subset of users in the at least one group, the method further includes generating the targeted communication for each user of the second subset of users in the at least one group, the targeted communication comprising a user-selectable link to at least one offer relevant to the at least one characteristic associated with the at least one group of the plurality of groups; and sending the targeted communication to a user device of each user of the second subset of users in the at least one group.

In some non-limiting embodiments or aspects, survey data is not received for the second subset of users.

In some non-limiting embodiments or aspects, the first machine learning model segments the second subset of users using a k-means clustering technique.

In some non-limiting embodiments or aspects, the method further includes evaluating the segmenting performed by the first machine learning model by generating a silhouette coefficient for at least one group of the plurality of groups.

In some non-limiting embodiments or aspects, the method further includes, in response to the silhouette coefficient not satisfying a threshold, updating the association of at least one transaction parameter of the plurality of transaction parameters with each group of the plurality of groups to associate at least one different transaction parameter with at least one group of the plurality of groups.

According to some non-limiting embodiments or aspects, provided is a system for segmenting users using a machine learning model based on transaction data. The system includes at least one processor programmed and/or configured to receive survey data and historical transaction data for a first subset of users, wherein for each user of the first subset of users, the survey data comprises a plurality of questions and a plurality of responses to the plurality of questions, and the historical transaction data comprises a plurality of transaction parameters associated with electronic payment transactions engaged in by a user of the first subset of users. The at least one processor is further programmed and/or configured to, based on the survey data, segment each user of the first subset of users into at least one group of a plurality of groups, wherein each group of the plurality of groups is associated with at least one characteristic. The at least one processor is further programmed and/or configured to analyze the historical transaction data for the first subset of users against the survey data and/or the at least one characteristic to associate at least one transaction parameter of the plurality of transaction parameters with each group of the plurality of groups. The at least one processor is further programmed and/or configured to receive data for a second subset of users, the second subset of users does not contain users from the first subset of users, the data comprises historical transaction data for the second subset of users. The at least one processor is further programmed and/or configured to, based on the historical transaction data for the second subset of users, segment, with a first machine learning model, each user of the second subset of users into at least one group of the plurality of groups. The at least one processor is further programmed and/or configured to, based on at least one characteristic associated with the at least one group of the plurality of groups, automatically transmit a targeted communication to each user of the second subset of users in the at least one group.

In some non-limiting embodiments or aspects, the at least one processor is further programmed and/or configured to generate the first machine learning model. In some non-limiting embodiments or aspects, when generating the first machine learning model, the at least one processor is programmed and/or configured to train the first machine learning model to perform a first task, the first task comprises segmenting each user of the second subset of users into at least one group of the plurality of groups based on inputting the historical transaction data for the second subset of users into the first machine learning model and based on the association of the at least one transaction parameter of the plurality of transaction parameters with each group of the plurality of groups.

In some non-limiting embodiments or aspects, the at least one processor is further programmed and/or configured to determine a plurality of characteristics based on the plurality of responses to the plurality of questions; and segment users from the first subset of users into the plurality of groups based on the plurality of characteristics, wherein each group of the plurality of groups is associated with at least one characteristics of the plurality of characteristics.

In some non-limiting embodiments or aspects, when segmenting each user of the first subset of users into at least one group of a plurality of groups, the at least one processor is programmed and/or configured to analyze the plurality of responses to the plurality of questions for each user of the first subset of users; determine at least one characteristic for each user of the first subset of users based on a respective plurality of responses to the plurality of questions for each user of the first subset of users; and segment each user of the first subset of users into at least one group of the plurality of groups based on the determined at least one characteristic for each user of the first subset of users.

In some non-limiting embodiments or aspects, when analyzing the historical transaction data for the first subset of users against the survey data and/or the at least one characteristic to associate at least one transaction parameter of the plurality of transaction parameters with each group of the plurality of groups, the at least one processor is programmed and/or configured to automatically analyze the historical transaction data for the first subset of users against the survey data and/or the at least one characteristic to associate at least one transaction parameter of the plurality of transaction parameters with each group of the plurality of groups using a second machine learning model.

In some non-limiting embodiments or aspects, when automatically transmitting a targeted communication to each user of the second subset of users in the at least one group, the at least one processor is programmed and/or configured to generate the targeted communication for each user of the second subset of users in the at least one group, the targeted communication comprising a user-selectable link to at least one offer relevant to the at least one characteristic associated with the at least one group of the plurality of groups; and send the targeted communication to a user device of each user of the second subset of users in the at least one group.

In some non-limiting embodiments or aspects, survey data is not received for the second subset of users.

In some non-limiting embodiments or aspects, the first machine learning model segments the second subset of users using a k-means clustering technique.

In some non-limiting embodiments or aspects, the at least one processor is further programmed and/or configured to evaluate the segmenting performed by the first machine learning model by generating a silhouette coefficient for at least one group of the plurality of groups; and in response to the silhouette coefficient not satisfying a threshold, update the association of at least one transaction parameter of the plurality of transaction parameters with each group of the plurality of groups to associate at least one different transaction parameter with at least one group of the plurality of groups.

According to some non-limiting embodiments or aspects, provided is a computer program product for segmenting users using a machine learning model based on transaction data. The computer program product comprising at least one non-transitory computer-readable medium including one or more instructions that, when executed by at least one processor, cause the at least one processor to receive survey data and historical transaction data for a first subset of users, wherein for each user of the first subset of users, the survey data comprises a plurality of questions and a plurality of responses to the plurality of questions, and the historical transaction data comprises a plurality of transaction parameters associated with electronic payment transactions engaged in by a user of the first subset of users. The one or more instructions may further cause the at least one processor to, based on the survey data, segment each user of the first subset of users into at least one group of a plurality of groups, wherein each group of the plurality of groups is associated with at least one characteristic. The one or more instructions may further cause the at least one processor to analyze the historical transaction data for the first subset of users against the survey data and/or the at least one characteristic to associate at least one transaction parameter of the plurality of transaction parameters with each group of the plurality of groups. The one or more instructions may further cause the at least one processor to receive data for a second subset of users, the second subset of users does not contain users from the first subset of users, the data comprises historical transaction data for the second subset of users. The one or more instructions may further cause the at least one processor to, based on the historical transaction data for the second subset of users, segment, with a machine learning model, each user of the second subset of users into at least one group of the plurality of groups. The one or more instructions may further cause the at least one processor to, based on at least one characteristic associated with the at least one group of the plurality of groups, automatically transmit a targeted communication to each user of the second subset of users in the at least one group.

In some non-limiting embodiments or aspects, the one or more instructions further cause the at least one processor to: generate the first machine learning model, wherein when generating the first machine learning model, the one or more instructions further cause the at least one processor to: train the first machine learning model to perform a first task, wherein the first task comprises segmenting each user of the second subset of users into at least one group of the plurality of groups based on inputting the historical transaction data for the second subset of users into the first machine learning model and based on the association of the at least one transaction parameter of the plurality of transaction parameters with each group of the plurality of groups.

In some non-limiting embodiments or aspects, the one or more instructions further cause the at least one processor to: determine a plurality of characteristics based on the plurality of responses to the plurality of questions; and segment users from the first subset of users into the plurality of groups based on the plurality of characteristics, wherein each group of the plurality of groups is associated with at least one characteristics of the plurality of characteristics.

In some non-limiting embodiments or aspects, when segmenting each user of the first subset of users into at least one group of a plurality of groups, the one or more instructions further cause the at least one processor to: analyze the plurality of responses to the plurality of questions for each user of the first subset of users; determine at least one characteristic for each user of the first subset of users based on a respective plurality of responses to the plurality of questions for each user of the first subset of users; and segment each user of the first subset of users into at least one group of the plurality of groups based on the determined at least one characteristic for each user of the first subset of users.

In some non-limiting embodiments or aspects, when analyzing the historical transaction data for the first subset of users against the survey data and/or the at least one characteristic to associate at least one transaction parameter of the plurality of transaction parameters with each group of the plurality of groups, the one or more instructions further cause the at least one processor to: automatically analyze the historical transaction data for the first subset of users against the survey data and/or the at least one characteristic to associate at least one transaction parameter of the plurality of transaction parameters with each group of the plurality of groups using a second machine learning model.

In some non-limiting embodiments or aspects, when automatically transmitting a targeted communication to each user of the second subset of users in the at least one group, the one or more instructions further cause the at least one processor to: generate the targeted communication for each user of the second subset of users in the at least one group, the targeted communication comprising a user-selectable link to at least one offer relevant to the at least one characteristic associated with the at least one group of the plurality of groups; and send the targeted communication to a user device of each user of the second subset of users in the at least one group.

In some non-limiting embodiments or aspects, survey data is not received for the second subset of users.

In some non-limiting embodiments or aspects, the first machine learning model segments the second subset of users using a k-means clustering technique.

In some non-limiting embodiments or aspects, the one or more instructions further cause the at least one processor to: evaluate the segmenting performed by the first machine learning model by generating a silhouette coefficient for at least one group of the plurality of groups; and in response to the silhouette coefficient not satisfying a threshold, update the association of at least one transaction parameter of the plurality of transaction parameters with each group of the plurality of groups to associate at least one different transaction parameter with at least one group of the plurality of groups.

Other non-limiting embodiments or aspects will be set forth in the following numbered clauses:
Clause 1: A computer-implemented method comprising: receiving survey data and historical transaction data for a first subset of users, wherein for each user of the first subset of users, the survey data comprises a plurality of questions and a plurality of responses to the plurality of questions, and the historical transaction data comprises a plurality of transaction parameters associated with electronic payment transactions engaged in by a user of the first subset of users; based on the survey data, segmenting each user of the first subset of users into at least one group of a plurality of groups, wherein each group of the plurality of groups is associated with at least one characteristic; analyzing the historical transaction data for the first subset of users against the survey data and/or the at least one characteristic to associate at least one transaction parameter of the plurality of transaction parameters with each group of the plurality of groups; receiving data for a second subset of users, wherein the second subset of users does not contain users from the first subset of users, wherein the data comprises historical transaction data for the second subset of users; based on the historical transaction data for the second subset of users, segmenting, with a first machine learning model, each user of the second subset of users into at least one group of the plurality of groups; and based on at least one characteristic associated with the at least one group of the plurality of groups, automatically transmitting a targeted communication to each user of the second subset of users in the at least one group.
Clause 2: The method of clause 1, further comprising: generating the first machine learning model, wherein generating the first machine learning model comprises training the first machine learning model to perform a first task, wherein the first task comprises segmenting each user of the second subset of users into at least one group of the plurality of groups based on inputting the historical transaction data for the second subset of users into the first machine learning model and based on the association of the at least one transaction parameter of the plurality of transaction parameters with each group of the plurality of groups.
Clause 3: The method of clause 1 or 2, further comprising: determining a plurality of characteristics based on the plurality of responses to the plurality of questions; and segmenting users from the first subset of users into the plurality of groups based on the plurality of characteristics, wherein each group of the plurality of groups is associated with at least one characteristic of the plurality of characteristics.
Clause 4: The method of any of clauses 1-3, wherein segmenting each user of the first subset of users into at least one group of the plurality of groups comprises: analyzing the plurality of responses to the plurality of questions for each user of the first subset of users; determining at least one characteristic for each user of the first subset of users based on a respective plurality of responses to the plurality of questions for each user of the first subset of users; and segmenting each user of the first subset of users into at least one group of the plurality of groups based on the determined at least one characteristic for each user of the first subset of users.
Clause 5: The method of any of clauses 1-4, wherein analyzing the historical transaction data for the first subset of users against the survey data and/or the at least one characteristic to associate at least one transaction parameter of the plurality of transaction parameters with each group of the plurality of groups comprises: automatically analyzing the historical transaction data for the first subset of users against the survey data and/or the at least one characteristic to associate at least one transaction parameter of the plurality of transaction parameters with each group of the plurality of groups using a second machine learning model.
Clause 6: The method of any of clauses 1-5, wherein automatically transmitting the targeted communication to each user of the second subset of users in the at least one group comprises: generating the targeted communication for each user of the second subset of users in the at least one group, the targeted communication comprising a user-selectable link to at least one offer relevant to the at least one characteristic associated with the at least one group of the plurality of groups; and sending the targeted communication to a user device of each user of the second subset of users in the at least one group.
Clause 7: The method of any of clauses 1-6, wherein survey data is not received for the second subset of users.
Clause 8: The method of any of clauses 1-7, wherein the first machine learning model segments the second subset of users using a k-means clustering technique.
Clause 9: The method of any of clauses 1-8, further comprising: evaluating the segmenting performed by the first machine learning model by generating a silhouette coefficient for at least one group of the plurality of groups.
Clause 10: The method of any of clauses 1-9, further comprising: in response to the silhouette coefficient not satisfying a threshold, updating the association of at least one transaction parameter of the plurality of transaction parameters with each group of the plurality of groups to associate at least one different transaction parameter with at least one group of the plurality of groups.
Clause 11: A system comprising: at least one processor programmed or configured to: receive survey data and historical transaction data for a first subset of users, wherein for each user of the first subset of users, the survey data comprises a plurality of questions and a plurality of responses to the plurality of questions, and the historical transaction data comprises a plurality of transaction parameters associated with electronic payment transactions engaged in by a user of the first subset of users; based on the survey data, segment each user of the first subset of users into at least one group of a plurality of groups, wherein each group of the plurality of groups is associated with at least one characteristic; analyze the historical transaction data for the first subset of users against the survey data and/or the at least one characteristic to associate at least one transaction parameter of the plurality of transaction parameters with each group of the plurality of groups; receive data for a second subset of users, wherein the second subset of users does not contain users from the first subset of users, wherein the data comprises historical transaction data for the second subset of users; based on the historical transaction data for the second subset of users, segment, with a first machine learning model, each user of the second subset of users into at least one group of the plurality of groups; and based on at least one characteristic associated with the at least one group of the plurality of groups, automatically transmit a targeted communication to each user of the second subset of users in the at least one group.
Clause 12: The system of clause 11, wherein the at least one processor is further programmed or configured to: generate the first machine learning model, wherein when generating the first machine learning model, the at least one processor is programmed or configured to: train the first machine learning model to perform a first task, wherein the first task comprises segmenting each user of the second subset of users into at least one group of the plurality of groups based on inputting the historical transaction data for the second subset of users into the first machine learning model and based on the association of the at least one transaction parameter of the plurality of transaction parameters with each group of the plurality of groups.
Clause 13: The system of clause 11 or 12, wherein the at least one processor is further programmed or configured to: determine a plurality of characteristics based on the plurality of responses to the plurality of questions; and segment users from the first subset of users into the plurality of groups based on the plurality of characteristics, wherein each group of the plurality of groups is associated with at least one characteristic of the plurality of characteristics.
Clause 14: The system of any of clauses 11-13, wherein when segmenting each user of the first subset of users into at least one group of a plurality of groups, the at least one processor is programmed or configured to: analyze the plurality of responses to the plurality of questions for each user of the first subset of users; determine at least one characteristic for each user of the first subset of users based on a respective plurality of responses to the plurality of questions for each user of the first subset of users; and segment each user of the first subset of users into at least one group of the plurality of groups based on the determined at least one characteristic for each user of the first subset of users.
Clause 15: The system of any of clauses 11-14, wherein when analyzing the historical transaction data for the first subset of users against the survey data and/or the at least one characteristic to associate at least one transaction parameter of the plurality of transaction parameters with each group of the plurality of groups, the at least one processor is programmed or configured to: automatically analyze the historical transaction data for the first subset of users against the survey data and/or the at least one characteristic to associate at least one transaction parameter of the plurality of transaction parameters with each group of the plurality of groups using a second machine learning model.
Clause 16: The system of clauses 11-15, wherein when automatically transmitting a targeted communication to each user of the second subset of users in the at least one group, the at least one processor is programmed or configured to: generate the targeted communication for each user of the second subset of users in the at least one group, the targeted communication comprising a user-selectable link to at least one offer relevant to the at least one characteristic associated with the at least one group of the plurality of groups; and send the targeted communication to a user device of each user of the second subset of users in the at least one group.
Clause 17: The system of clauses 11-16, wherein survey data is not received for the second subset of users.
Clause 18: The system of clauses 11-17, wherein the first machine learning model segments the second subset of users using a k-means clustering technique.
Clause 19: The system of clauses 11-18, wherein the at least one processor is further programmed or configured to: evaluate the segmenting performed by the first machine learning model by generating a silhouette coefficient for at least one group of the plurality of groups; and in response to the silhouette coefficient not satisfying a threshold, update the association of at least one transaction parameter of the plurality of transaction parameters with each group of the plurality of groups to associate at least one different transaction parameter with at least one group of the plurality of groups.
Clause 20: A computer program product, the computer program product comprising at least one non-transitory computer-readable medium including one or more instructions that, when executed by at least one processor, cause the at least one processor to: receive survey data and historical transaction data for a first subset of users, wherein for each user of the first subset of users, the survey data comprises a plurality of questions and a plurality of responses to the plurality of questions, and the historical transaction data comprises a plurality of transaction parameters associated with electronic payment transactions engaged in by a user of the first subset of users; based on the survey data, segment each user of the first subset of users into at least one group of a plurality of groups, wherein each group of the plurality of groups is associated with at least one characteristic; analyze the historical transaction data for the first subset of users against the survey data and/or the at least one characteristic to associate at least one transaction parameter of the plurality of transaction parameters with each group of the plurality of groups; receive data for a second subset of users, wherein the second subset of users does not contain users from the first subset of users, wherein the data comprises historical transaction data for the second subset of users; based on the historical transaction data for the second subset of users, segment, with a machine learning model, each user of the second subset of users into at least one group of the plurality of groups; and based on at least one characteristic associated with the at least one group of the plurality of groups, automatically transmit a targeted communication to each user of the second subset of users in the at least one group.
Clause 21: The computer program product of clause 20, wherein the one or more instructions further cause the at least one processor to: generate the first machine learning model, wherein when generating the first machine learning model, the one or more instructions further cause the at least one processor to: train the first machine learning model to perform a first task, wherein the first task comprises segmenting each user of the second subset of users into at least one group of the plurality of groups based on inputting the historical transaction data for the second subset of users into the first machine learning model and based on the association of the at least one transaction parameter of the plurality of transaction parameters with each group of the plurality of groups.
Clause 22: The computer program product of clause 20 or 21, wherein the one or more instructions further cause the at least one processor to: determine a plurality of characteristics based on the plurality of responses to the plurality of questions; and segment users from the first subset of users into the plurality of groups based on the plurality of characteristics, wherein each group of the plurality of groups is associated with at least one characteristics of the plurality of characteristics.
Clause 23: The computer program product of any of clauses 20-22, wherein when segmenting each user of the first subset of users into at least one group of a plurality of groups, the one or more instructions further cause the at least one processor to: analyze the plurality of responses to the plurality of questions for each user of the first subset of users; determine at least one characteristic for each user of the first subset of users based on a respective plurality of responses to the plurality of questions for each user of the first subset of users; and segment each user of the first subset of users into at least one group of the plurality of groups based on the determined at least one characteristic for each user of the first subset of users.
Clause 24: The computer program product of any of clauses 20-23, wherein when analyzing the historical transaction data for the first subset of users against the survey data and/or the at least one characteristic to associate at least one transaction parameter of the plurality of transaction parameters with each group of the plurality of groups, the one or more instructions further cause the at least one processor to: automatically analyze the historical transaction data for the first subset of users against the survey data and/or the at least one characteristic to associate at least one transaction parameter of the plurality of transaction parameters with each group of the plurality of groups using a second machine learning model.
Clause 25: The computer program product of clauses 20-24, wherein when automatically transmitting a targeted communication to each user of the second subset of users in the at least one group, the one or more instructions further cause the at least one processor to: generate the targeted communication for each user of the second subset of users in the at least one group, the targeted communication comprising a user-selectable link to at least one offer relevant to the at least one characteristic associated with the at least one group of the plurality of groups; and send the targeted communication to a user device of each user of the second subset of users in the at least one group.
Clause 26: The computer program product of clauses 20-25, wherein survey data is not received for the second subset of users.
Clause 27: The computer program product of clauses 20-26, wherein the first machine learning model segments the second subset of users using a k-means clustering technique.
Clause 28: The computer program product of clauses 20-27, wherein the one or more instructions further cause the at least one processor to: evaluate the segmenting performed by the first machine learning model by generating a silhouette coefficient for at least one group of the plurality of groups; and in response to the silhouette coefficient not satisfying a threshold, update the association of at least one transaction parameter of the plurality of transaction parameters with each group of the plurality of groups to associate at least one different transaction parameter with at least one group of the plurality of groups.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a diagram of a non-limiting embodiment or aspect of an environment in which systems, devices, products, apparatus, and/or methods, described herein, may be implemented according to the principles of the present disclosure;

FIG. 2 is a diagram of a non-limiting embodiment or aspect of components of one or more devices of FIG. 1;

FIG. 3 is a flowchart of a non-limiting embodiment or aspect of a process for segmenting users using a machine learning model based on transaction data; and

FIGS. 4A-4K are diagrams of non-limiting embodiments or aspects of an implementation of a process for segmenting users using a machine learning model based on transaction data.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases and original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Provided are systems, methods, and computer program products for segmenting users using a machine learning model based on transaction data. Non-limiting embodiments or aspects of the present disclosure may include a system that includes at least one processor programmed or configured to receive survey data and historical transaction data for a first subset of users, where, for each user of the first subset of users, the survey data comprises a plurality of questions and a plurality of responses to the plurality of questions, and the historical transaction data comprises a plurality of transaction parameters associated with electronic payment transactions engaged in by a user. In some non-limiting embodiments or aspects, the processor may be programmed or configured to, based on the survey data, segment each user of the first subset of users into at least one group of a plurality of groups, where each group of the plurality of groups is associated with at least one characteristic. In some non-limiting embodiments or aspects, the processor may be programmed or configured to analyze the historical transaction data for the first subset of users against the survey data and/or the at least one characteristic to associate at least one transaction parameter of the plurality of transaction parameters with each group of the plurality of groups. In some non-limiting embodiments or aspects, the processor may be programmed or configured to receive data for a second subset of users, where the second subset of users does not contain users from the first subset of users, and where the data comprises historical transaction data for the second subset of users. In some non-limiting embodiments or aspects, the processor may be programmed or configured to, based on the historical transaction data for the second subset of users, segment, with a machine learning model, each user of the second subset of users into at least one group of the plurality of groups. In some non-limiting embodiments or aspects, the processor may be programmed or configured to, based on at least one characteristic associated with the at least one group of the plurality of groups, automatically transmit a targeted communication to each user of the second subset of users in the at least one group.

In some non-limiting embodiments or aspects, the processor may be programmed or configured to generate the machine learning model. When generating the machine learning model, the at least one processor may be programmed or configured to train the machine learning model to perform a first task, where the first task comprises segmenting each user of the second subset of users into at least one group of the plurality of groups based on inputting the historical transaction data for the second subset of users into the machine learning model and based on the association of the at least one transaction parameter of the plurality of transaction parameters with each group of the plurality of groups.

In some non-limiting embodiments or aspects, the processor may be programmed or configured to determine a plurality of characteristics based on the plurality of responses to the plurality of questions; and segment users from the first subset of users into the plurality of groups based on the plurality of characteristics, where each group of the plurality of groups is associated with at least one characteristic of the plurality of characteristics.

In some non-limiting embodiments or aspects, when segmenting each user of the first subset of users into at least one group of a plurality of groups, the at least one processor may be programmed or configured to: analyze the plurality of responses to the plurality of questions for each user of the first subset of users; determine at least one characteristic for each user of the first subset of users based on a respective plurality of responses to the plurality of questions for each user of the first subset of users; and segment each user of the first subset of users into at least one group of the plurality of groups based on the determined at least one characteristic for each user of the first subset of users.

In some non-limiting embodiments or aspects, when analyzing the historical transaction data for the first subset of users against the survey data and/or the at least one characteristic to associate at least one transaction parameter of the plurality of transaction parameters with each group of the plurality of groups, the at least one processor may be programmed or configured to automatically analyze the historical transaction data for the first subset of users against the survey data and/or the at least one characteristic to associate at least one transaction parameter of the plurality of transaction parameters with each group of the plurality of groups using a second machine learning model.

In some non-limiting embodiments or aspects, when automatically transmitting a targeted communication to each user of the second subset of users in the at least one group, the at least one processor may be programmed or configured to generate the targeted communication for each user of the second subset of users in the at least one group, the targeted communication comprising a user-selectable link to at least one offer relevant to the at least one characteristic associated with the at least one group of the plurality of groups; and send the targeted communication to a user device of each user of the second subset of users in the at least one group.

In some non-limiting embodiments or aspects, survey data is not received for the second subset of users.

In some non-limiting embodiments or aspects, the machine learning model segments the second subset of users using a k-means clustering technique.

In some non-limiting embodiments or aspects, the at least one processor is programmed or configured to evaluate the segmenting performed by the machine learning model by generating a silhouette coefficient for at least one group of the plurality of groups; and in response to the silhouette coefficient not satisfying a threshold, update the association of at least one transaction parameter of the plurality of transaction parameters with each group of the plurality of groups to associate at least one different transaction parameter with at least one group of the plurality of groups.

In this way, non-limiting embodiments or aspects of the present disclosure may use clustering algorithms to segment cardholders behaving similarly based on historical transaction data that can be mapped by a machine learning model to persona characteristics determined by analyzing surveys. The survey data (e.g., questions and responses) received from certain users may be analyzed and translated into transaction data. Then, clustering and/or segmentation may be performed using the machine learning model for users who have not completed a survey based on the user's transaction data and the mapping between the historical transaction data and persona characteristics. Such segmentation may be used to automatically, efficiently, and empirically generate and transmit relevant and targeted communications (e.g., advertisements) to users of a cluster, including for users who do not have associated survey data. Thus, for this second group of users not having survey data, their existing historical transaction data may be analyzed using machine learning models to extract user data regarding their persona characteristics, eliminating the need for surveys for the second subset of users. The use of readily available transaction data in such a way eliminates the need for surveys that are commonly used to execute and/or measure the effectiveness of marketing campaigns. This present disclosure also provides more accurate results and reduces both the time and cost of such evaluations.

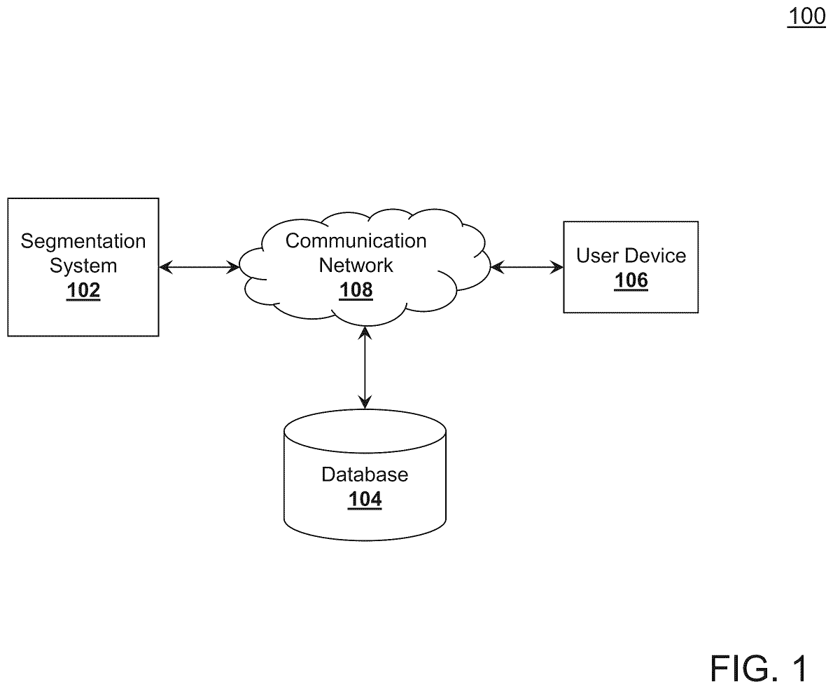

Referring now to FIG. 1, shown is a diagram of an example environment 100 in which devices, systems, and/or methods, described herein, may be implemented. As shown in FIG. 1, environment 100 includes segmentation system 102, database 104, user device 106, and communication network 108. Segmentation system 102, database 104, and/or user device 106 may interconnect (e.g., establish a connection to communicate) via wired connections, wireless connections, or a combination of wired and wireless connections.

Segmentation system 102 may include one or more devices configured to communicate with database 104 and/or user device 106 via communication network 108. For example, segmentation system 102 may include a server, a group of servers, and/or other like devices. In some non-limiting embodiments or aspects, segmentation system 102 may be associated with a transaction service provider system, as described herein.

In some non-limiting embodiments or aspects, segmentation system 102 may generate (e.g., train, validate, retrain, and/or the like), store, and/or implement (e.g., operate, provide inputs to and/or outputs from, and/or the like) one or more machine learning models. In some non-limiting embodiments or aspects, segmentation system 102 may be in communication with a data storage device, which may be local or remote to segmentation system 102. In some non-limiting embodiments or aspects, segmentation system 102 may be capable of receiving information from, storing information in, transmitting information to, and/or searching information stored in database 104.

Database 104 may include one or more devices configured to communicate with segmentation system 102 and/or user device 106 via communication network 108. For example, database 104 may include a computing device, such as a server, a group of servers, and/or other like devices. In some non-limiting embodiments or aspects, database 104 may be associated with a transaction service provider system as discussed herein.

User device 106 may include a computing device configured to communicate with segmentation system 102 and/or database 104 via communication network 108. For example, user device 106 may include a computing device, such as a desktop computer, a portable computer (e.g., a tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106).

Communication network 108 may include one or more wired and/or wireless networks. For example, communication network 108 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

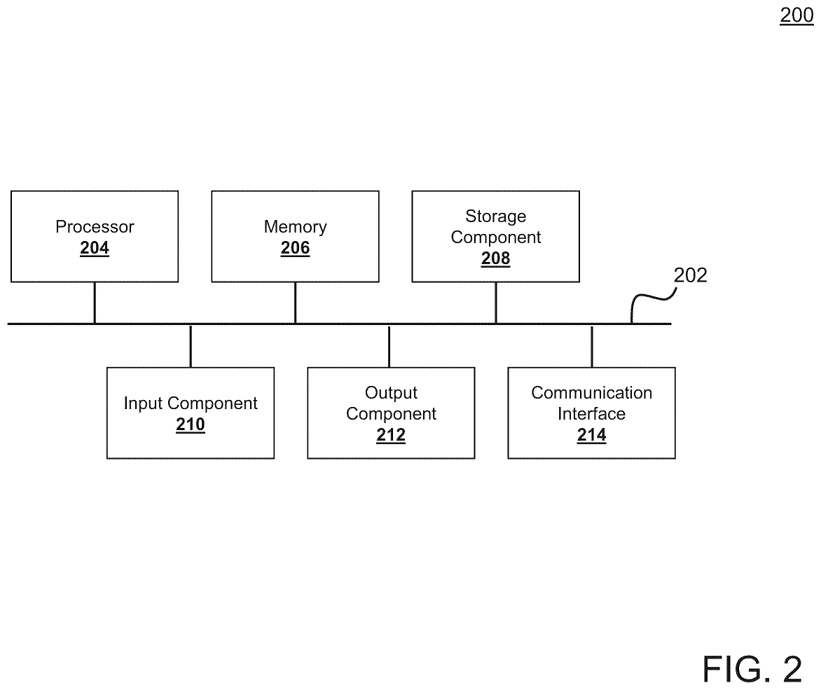

Referring now to FIG. 2, shown is a diagram of example components of a device 200. Device 200 may correspond to segmentation system 102 (e.g., one or more devices of segmentation system 102), database 104 (e.g., one or more devices of database 104), and/or user device 106. In some non-limiting embodiments or aspects, segmentation system 102, database 104, and/or user device 106 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

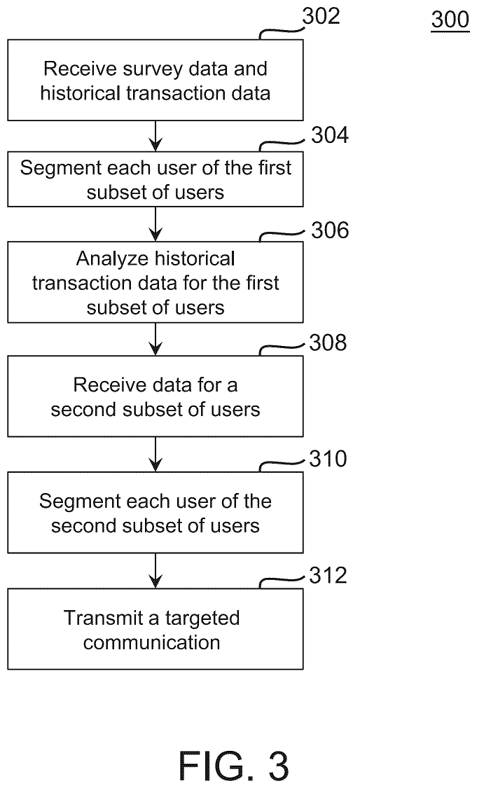

Referring now to FIG. 3, shown is a flowchart of a non-limiting embodiment or aspect of a process 300 for segmenting users using a machine learning model based on transaction data. In some non-limiting embodiments or aspects, one or more steps of process 300 may be performed (e.g., completely, partially, etc.) by segmentation system 102 (e.g., one or more devices of segmentation system 102). In some non-limiting embodiments or aspects, one or more steps of process 300 may be performed (e.g., completely, partially, etc.) by another device or group of devices separate from or including segmentation system 102 (e.g., one or more devices of segmentation system 102), database 104 (e.g., one or more devices of database 104), and/or user device 106.

As shown in FIG. 3, at step 302, process 300 includes receiving survey data and historical transaction data. For example, segmentation system 102 may receive (e.g., from database 104) survey data and/or historical transaction data. In some non-limiting embodiments or aspects, segmentation system 102 may receive survey data and historical transaction data for a first subset of users. In some non-limiting embodiments or aspects, the first subset of users may include a first plurality of users.

In some non-limiting embodiments or aspects, the survey data may include a plurality of questions and a plurality of responses to the plurality of questions. For example, the survey data may include a plurality of questions and a plurality of responses to the plurality of questions for each user of the first subset of users. In some non-limiting embodiments or aspects, survey data is only received for the first subset of users.

In some non-limiting embodiments or aspects, the historical transaction data may include transaction data for a plurality of transactions. In some non-limiting embodiments or aspects, the historical transaction data may include a plurality of transaction parameters associated with electronic payment transactions engaged in by a user of the first subset of users. Transaction parameters may include, but are not limited to, electronic wallet card data associated with an electronic card (e.g., an electronic credit card, an electronic debit card, an electronic loyalty card, and/or the like), decision data associated with a decision (e.g., a decision to approve or deny a transaction authorization request), authorization data associated with an authorization response (e.g., an approved spending limit, an approved transaction value, and/or the like), a primary account number (PAN), an authorization code (e.g., a personal identification number, etc.), data associated with a transaction amount (e.g., an approved limit, a transaction value, etc.), data associated with a transaction date and time, data associated with a conversion rate of a currency, data associated with a merchant type (e.g., goods, grocery, fuel, and/or the like), data associated with an acquiring institution country, data associated with an identifier of a country associated with the PAN, data associated with a response code, data associated with a merchant identifier (e.g., a merchant name, a merchant location, and/or the like), data associated with a type of currency corresponding to funds stored in association with the PAN, and/or the like. The transaction parameters may comprise data elements defined by ISO 8583.

In some non-limiting embodiments or aspects, segmentation system 102 may receive a training dataset. In some non-limiting embodiments or aspects, the training dataset may include the survey data for the first subset of users and/or the historical transaction data for the first subset of users. In some non-limiting embodiments or aspects, the training dataset may include a plurality of training samples. In some non-limiting embodiments or aspects, the plurality of training samples may be labeled or unlabeled. In some non-limiting embodiments or aspects, the training dataset may be stored in a storage component and/or stored in database 104.

As shown in FIG. 3, at step 304, process 300 includes segmenting each user of the first subset of users. For example, segmentation system 102 may segment each user of the first subset of users. In some non-limiting embodiments or aspects, segmentation system 102 may segment each user of the first subset of users into at least one group of a plurality of groups. For example, segmentation system 102 may, based on the survey data, segment each user of the first subset of users into at least one group of the plurality of groups. In some non-limiting embodiments or aspects, each group of the plurality of groups may be associated with at least one characteristic.

In some non-limiting embodiments or aspects, segmentation system 102 may determine a plurality of characteristics. For example, segmentation system 102 may determine a plurality of characteristics based on the plurality of responses to the plurality of questions. In some non-limiting embodiments or aspects, segmentation system 102 may segment users from the first subset of users into the plurality of groups based on the plurality of characteristics. In some non-limiting embodiments or aspects, each group of the plurality of groups may be associated with at least one characteristic of the plurality of characteristics.

In some non-limiting embodiments or aspects, segmenting each user of the first subset of users into at least one group of the plurality of groups may include analyzing the plurality of responses to the plurality of questions for each user of the first subset of users. For example, when segmenting each user of the first subset of users into at least one group of the plurality of groups, segmentation system 102 may analyze the plurality of responses to the plurality of questions for each user of the first subset of users. Additionally or alternatively, segmenting each user of the first subset of users into at least one group of the plurality of groups may include determining at least one characteristic for each user of the first subset of users based on a respective plurality of responses to the plurality of questions for each user of the first subset of users. For example, when segmenting each user of the first subset of users into at least one group of the plurality of groups, segmentation system 102 may determine at least one characteristic for each user of the first subset of users based on a respective plurality of responses to the plurality of questions for each user of the first subset of users. Additionally or alternatively, segmenting each user of the first subset of users into at least one group of the plurality of groups may include segmenting each user of the first subset of users into at least one group of the plurality of groups based on the determined at least one characteristic for each user of the first subset of users. For example, when segmenting each user of the first subset of users into at least one group of the plurality of groups, segmentation system 102 may segment each user of the first subset of users into at least one group of the plurality of groups based on the determined at least one characteristic for each user of the first subset of users.

As shown in FIG. 3, at step 306, process 300 includes analyzing historical transaction data for the first subset of users. For example, segmentation system 102 may analyze historical transaction data for the first subset of users. In some non-limiting embodiments or aspects, segmentation system 102 may analyze the historical transaction data for the first subset of users against the survey data and/or the at least one characteristic. For example, segmentation system 102 may analyze the historical transaction data for the first subset of users against the survey data and/or the at least one characteristic to associate at least one transaction parameter of the plurality of transaction parameters with each group of the plurality of groups.

In some non-limiting embodiments or aspects, step 306 may be performed by one or more machine learning models. In some non-limiting embodiments or aspects, analyzing the historical transaction data for the first subset of users against the survey data and/or the at least one characteristic to associate at least one transaction parameter of the plurality of transaction parameters with each group of the plurality of groups may include automatically analyzing the historical transaction data for the first subset of users against the survey data and/or the at least one characteristic to associate at least one transaction parameter of the plurality of transaction parameters with each group of the plurality of groups using a second machine learning model. For example, when analyzing the historical transaction data for the first subset of users against the survey data and/or the at least one characteristic to associate at least one transaction parameter of the plurality of transaction parameters with each group of the plurality of groups, segmentation system 102 may automatically analyze the historical transaction data for the first subset of users against the survey data and/or the at least one characteristic to associate at least one transaction parameter of the plurality of transaction parameters with each group of the plurality of groups using a second machine learning model.

In some non-limiting embodiments or aspects, the second machine learning model may include one or more machine learning models. In some non-limiting embodiments or aspects, segmentation system 102 may generate (e.g., train, validate, retrain, and/or the like), store, and/or implement (e.g., operate, provide inputs to and/or outputs from, and/or the like) the second machine learning model. In some non-limiting embodiments or aspects, segmentation system 102 may provide a trained second machine learning model. In some non-limiting embodiments or aspects, the second machine learning model may be trained to perform a second task. The second task may include associating at least one transaction parameter of the plurality of transaction parameters with each group of the plurality of groups based on inputting the historical transaction data into the second machine learning model.

As shown in FIG. 3, at step 308, process 300 includes receiving data for a second subset of users. For example, segmentation system 102 may receive (e.g., from database 104) data for the second subset of users. In some non-limiting embodiments or aspects, segmentation system 102 may receive historical transaction data for the second subset of users. For example, segmentation system 102 may receive historical transaction data for each user of the second subset of users. In some non-limiting embodiments or aspects, the second subset of users may include a second plurality of users. In some non-limiting embodiments or aspects, the second plurality of users may be different than the first plurality of users. For example, the second plurality of users may not include users from the first subset of users.

In some non-limiting embodiments or aspects, the data for the second subset of users may include data associated with one or more transactions. In some non-limiting embodiments or aspects, the data for the second subset of users may be transaction data associated with electronic payment transactions engaged in by the second subset of users. The transaction data may include the transaction parameters as previously described.

In some non-limiting embodiments or aspects, the data for the second subset of users may not include any survey data. The second subset of users may not have completed the survey completed by the first subset of users.

In some non-limiting embodiments or aspects, upon receiving the data for the second subset of users, segmentation system 102 may provide the data for the second subset of users as the input to one or more machine learning models. In some non-limiting embodiments or aspects, segmentation system 102 may receive the data for the second subset of users corresponding to an output from one or more machine learning models. In some non-limiting embodiments or aspects, segmentation system 102 may input the data for the second subset of users corresponding to the output from one or more machine learning models into another one or more machine learning models.

In some non-limiting embodiments or aspects, segmentation system 102 may use machine learning techniques to analyze the data for the second subset of users to train one or more machine learning models and/or provide one or more trained machine learning models. The machine learning model techniques may include, but are not limited to, supervised learning, unsupervised learning, and/or the like.

As shown in FIG. 3, at step 310, process 300 includes segmenting each user of the second subset of users. For example, segmentation system 102 may segment each user of the second subset of users. In some non-limiting embodiments or aspects, segmentation system 102 may segment each user of the second subset of users based on the historical transaction data for the second subset of users. For example, based on the historical transaction data, segmentation system 102 may segment each user of the second subset of users into at least one group of the plurality of groups.

In some non-limiting embodiments or aspects, segmentation system 102 may segment each user of the second subset of users with a first machine learning model. For example, based on the historical transaction data for the second subset of users, segmentation system 102 may segment, with a first machine learning model, each user of the second subset of users into at least one group of the plurality of groups.

In some non-limiting embodiments or aspects, the first machine learning model may include or more machine learning models. In some non-limiting embodiments or aspects, segmentation system 102 may generate (e.g., build, train, validate, etc.) the first machine learning model. In some non-limiting embodiments or aspects, segmentation system 102 may provide a first trained machine learning model. In some non-limiting embodiments or aspects, generating the first machine learning model may include training the first machine learning model to perform a first task. For example, segmentation system 102 may train the first machine learning model to perform a first task using the data from the second subset of users. In some non-limiting embodiments or aspects, the first task may include segmenting each user of the second subset of users into at least one group of the plurality of groups. For example, segmentation system 102 may train the first machine learning model to perform the first task, where the first task includes segmenting each user of the second subset of users into at least one group of the plurality of groups based on inputting the historical transaction data for the second subset of users into the first machine learning model. The first machine learning model may segment each user of the second subset of users into at least one group of the plurality of groups based on the historical transaction data of the second subset of users and without survey data for the second subset of users. In some non-limiting embodiments or aspects, the first machine learning model may be trained to perform one or more additional tasks. In some non-limiting embodiments or aspects, the second machine learning model may be part of the first machine learning model. In some non-limiting embodiments or aspects, an output of the first machine learning model may be input into the second machine learning model and/or an output of the second machine learning model may be input into the first machine learning model.

In some non-limiting embodiments or aspects, the first machine learning model may use a clustering algorithm. The clustering algorithm may be partitioning based, hierarchical based, density based, and/or the like. The clustering algorithm may be a k-means algorithm, an agglomerative algorithm, and/or a DbScan algorithm. In some non-limiting embodiments or aspects, segmentation system 102 may segment the second subset of users using a k-means clustering technique. For example, the first machine learning model may segment the second subset of users using a k-means clustering technique. A k-means clustering technique may be a method of vector quantization which segments the data input into the first machine learning model into a number of clusters, denoted by k, in which each data point belongs to the cluster with the nearest mean value.

In some non-limiting embodiments or aspects, the machine learning model may be an unsupervised machine learning model. In some non-limiting embodiments or aspects, the machine learning model may cluster the second subset of users into a plurality of segments. The number of segments may be predetermined. The segments may correspond to the groups.

In some non-limiting embodiments or aspects, segmentation system 102 may evaluate the segmenting performed by the machine learning model. For example, segmentation system 102 may evaluate the segmenting performed by the machine learning model by generating a silhouette coefficient for at least one group (e.g., a cluster generated as a result of the modeling) of the plurality of groups. In some non-limiting embodiments or aspects, segmentation system 102 may update the association of at least one transaction parameter of the plurality of transaction parameters. For example, segmentation system 102 may update the association of at least one transaction parameter of the plurality of parameters with each group of the plurality of groups to associate at least one different transaction parameter with at least one group of the plurality of groups. The segmentation system 102 may update the association of at least one transaction parameter of the plurality of parameters with each group of the plurality of groups when the silhouette coefficient does not satisfy a threshold, indicating that the association of the transaction parameter(s) with the group(s) is not validated as creating a cluster of users having sufficient similarity.

As shown in FIG. 3, at step 312, process 300 includes transmitting a targeted communication. For example, segmentation system 102 may transmit a targeted communication to user device 106. In some non-limiting embodiments or aspects, segmentation system 102 may automatically transmit a targeted communication to each user of the second subset of users in the at least one group. For example, based on at least one characteristic associated with the at least one group of the plurality of groups, segmentation system 102 may automatically transmit a targeted communication to each user of the second subset of users in the at least one group.

In some non-limiting embodiments or aspects, automatically transmitting the targeted communication to each user of the second subset of users in the at least one group may include generating the targeted communication for each user of the second subset of users in the at least one group. For example, segmentation system 102 may generate the targeted communication for each user of the second subset of users in the at least one group. In some non-limiting embodiments or aspects, the targeted communication may include a user-selectable link to at least one offer relevant to the at least one characteristic associated with the at least one group of the plurality of groups such that the communication is relatively more likely (compared to a random or blanket offer campaign) to be relevant to the user receiving the communication and/or more likely to cause the user to initiate a transaction in response to receiving the offer. Additionally or alternatively, automatically transmitting the targeted communication to each user of the second subset of users in the at least one group may include sending the targeted communication to a user device of each user of the second subset of users in the at least one group. For example, segmentation system 102 may send the targeted communication to user device 106.

In some non-limiting embodiments or aspects, user device 106 may display data associated with the targeted communication via a graphical user interface (GUI). In some non-limiting embodiments or aspects, the GUI may be an interactive GUI. In some non-limiting embodiments or aspects, the interactive GUI may include one or more selection options. The one or more selection options may be configured to receive a selection from a user of user device 106. The interactive GUI may be configured to be updated based on receiving a selection of the one or more selection options from the user. In some non-limiting embodiments or aspects, the interactive GUI may include one or more data inputs. In some non-limiting embodiments or aspects, the interactive GUI may be configured to be updated based on receiving one or more data inputs from the user.

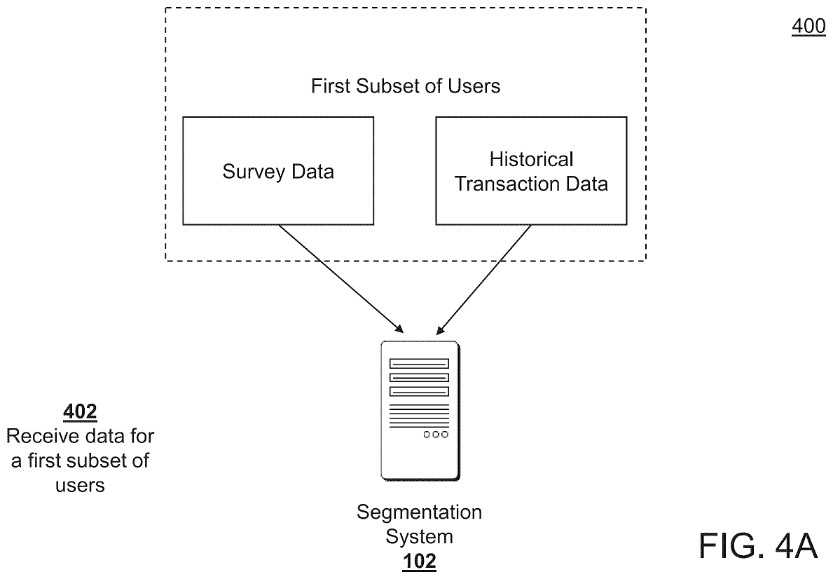

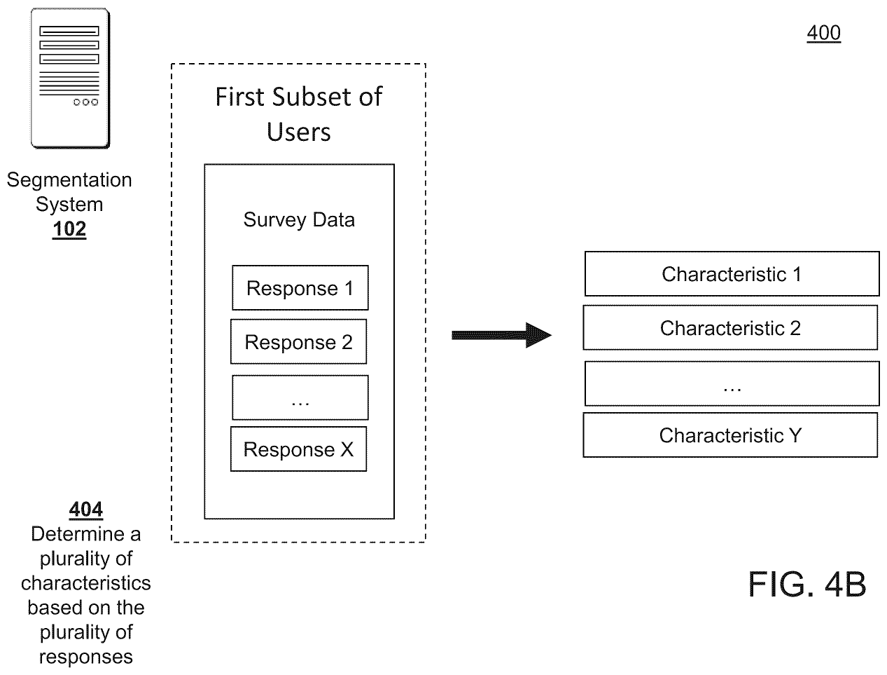

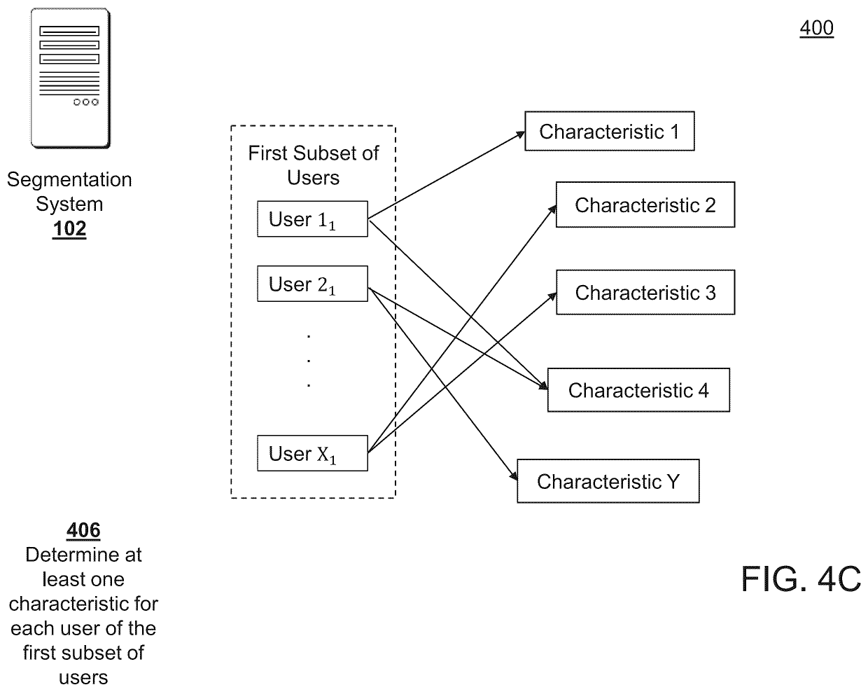

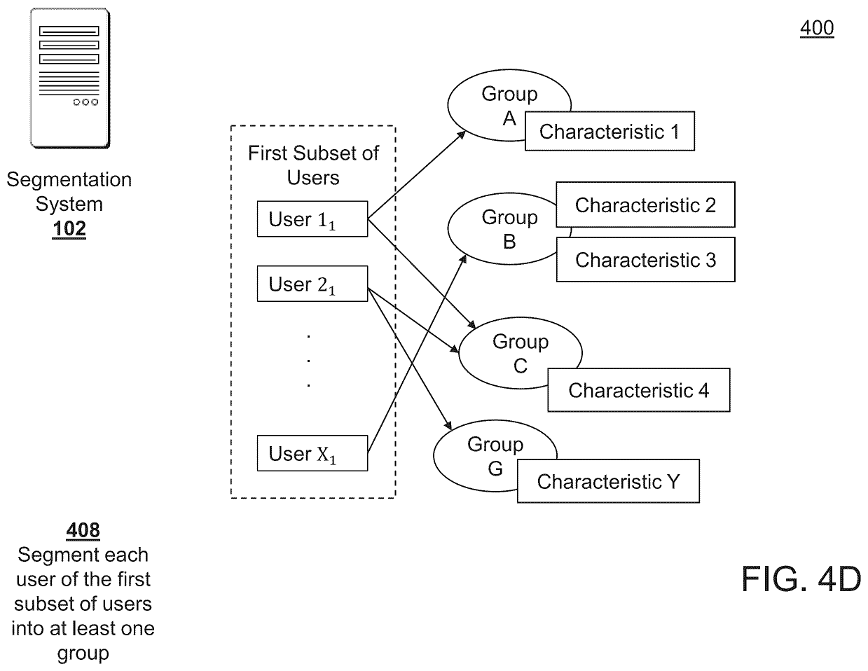

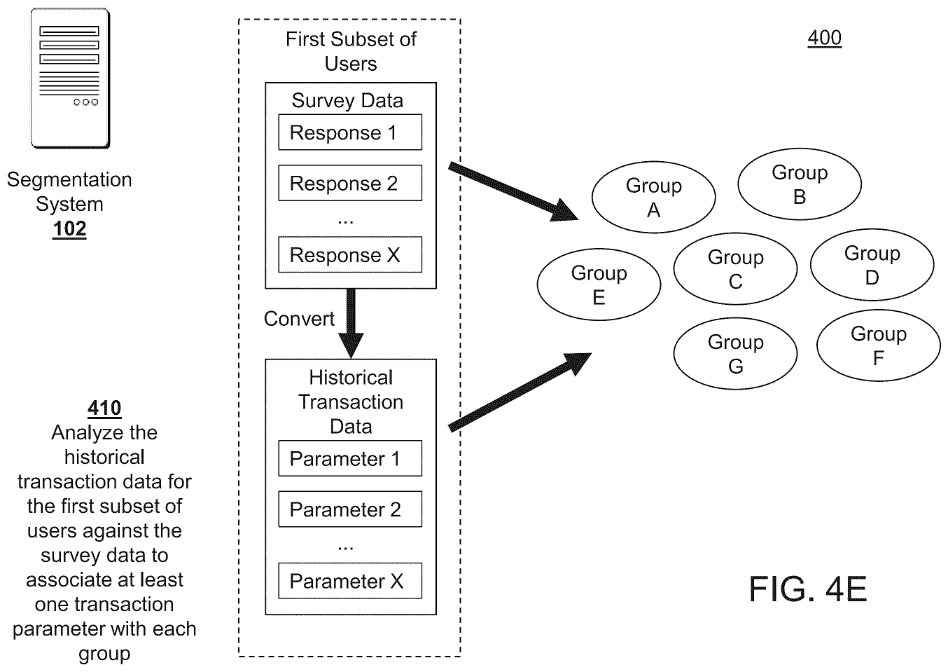

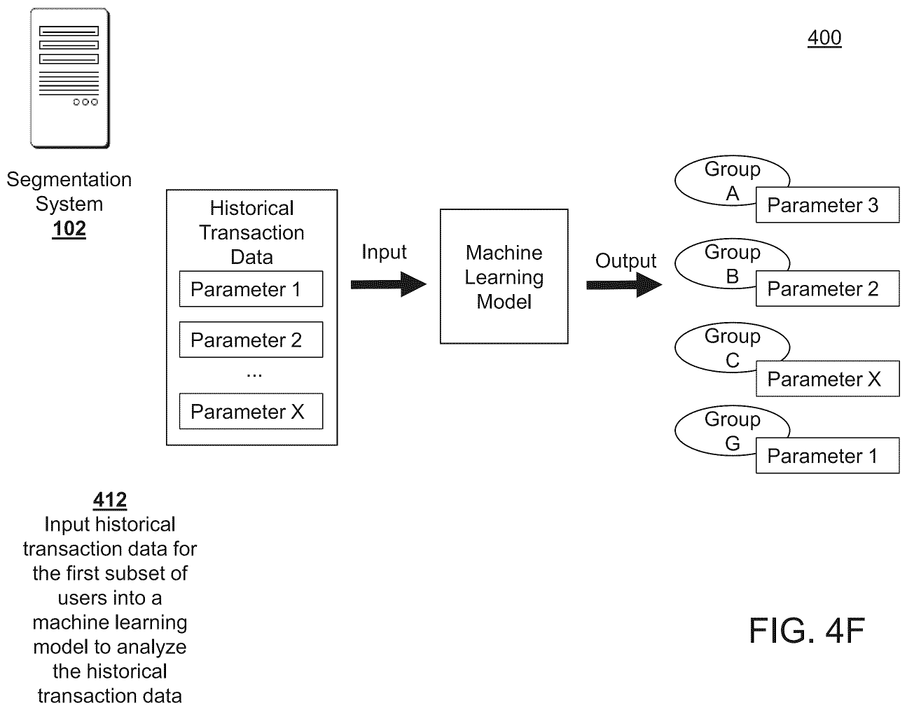

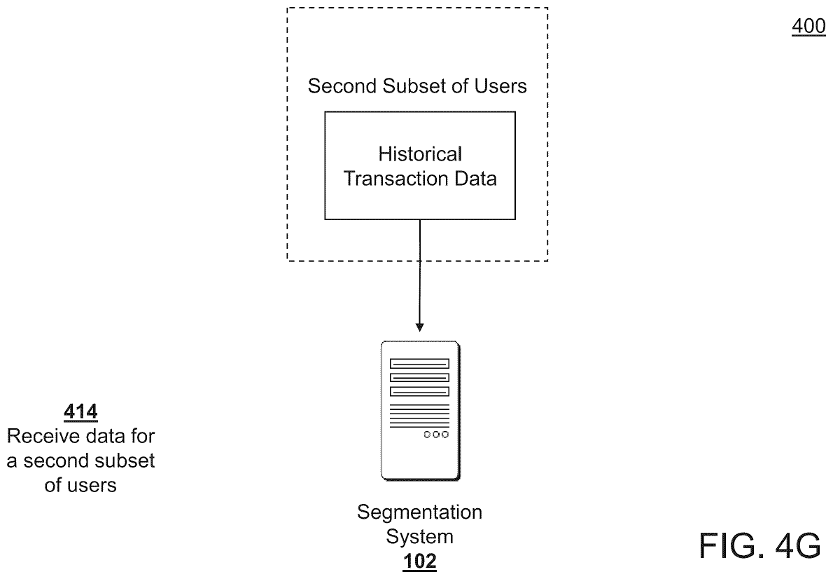

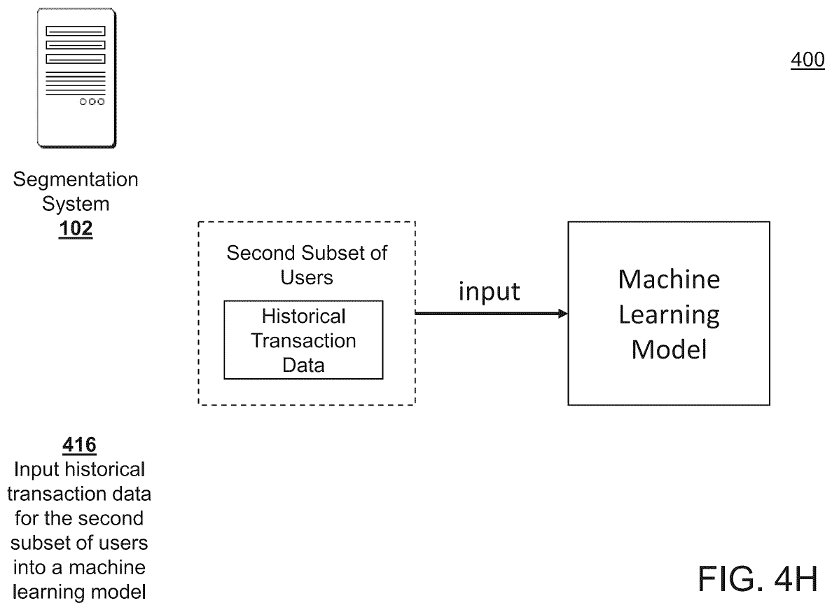

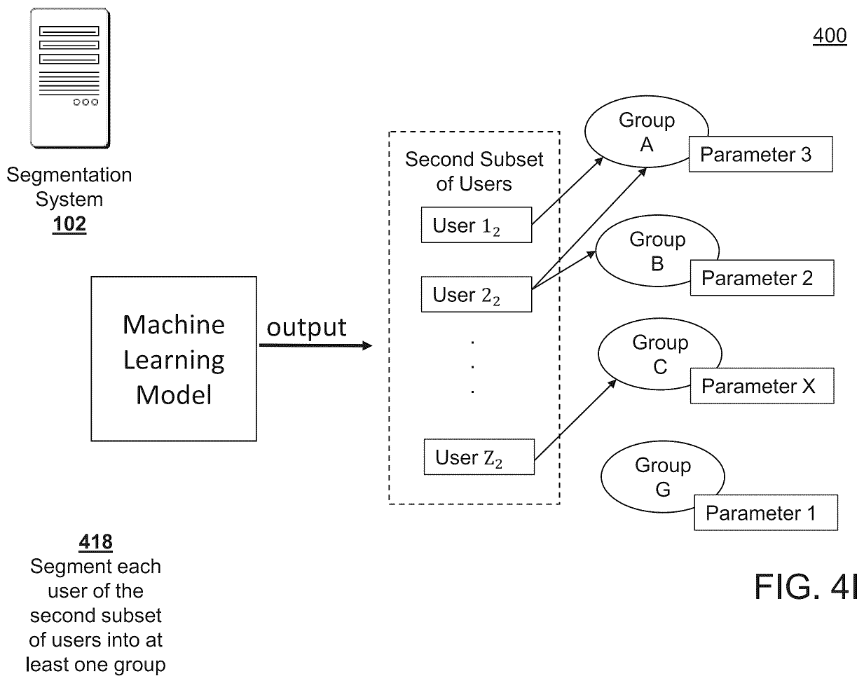

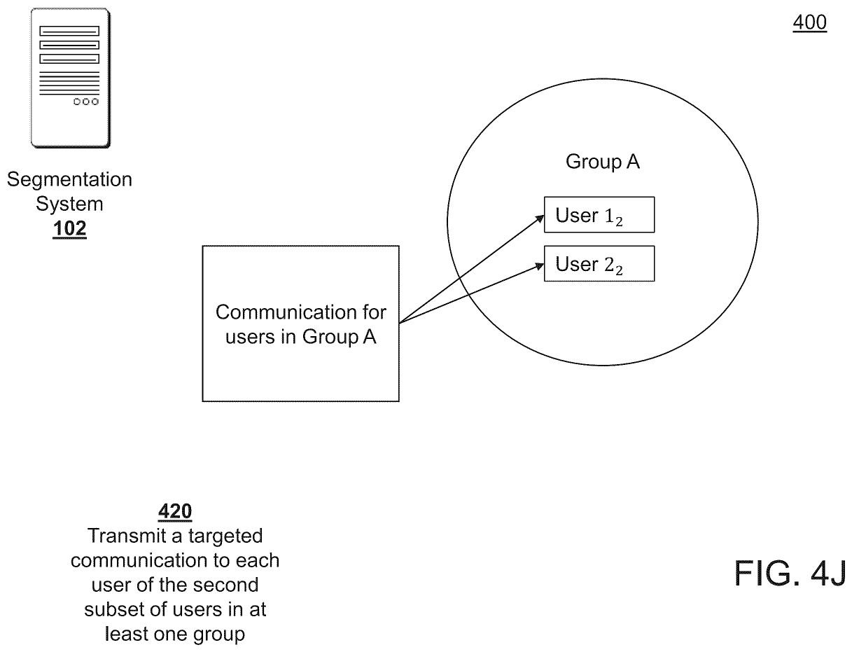

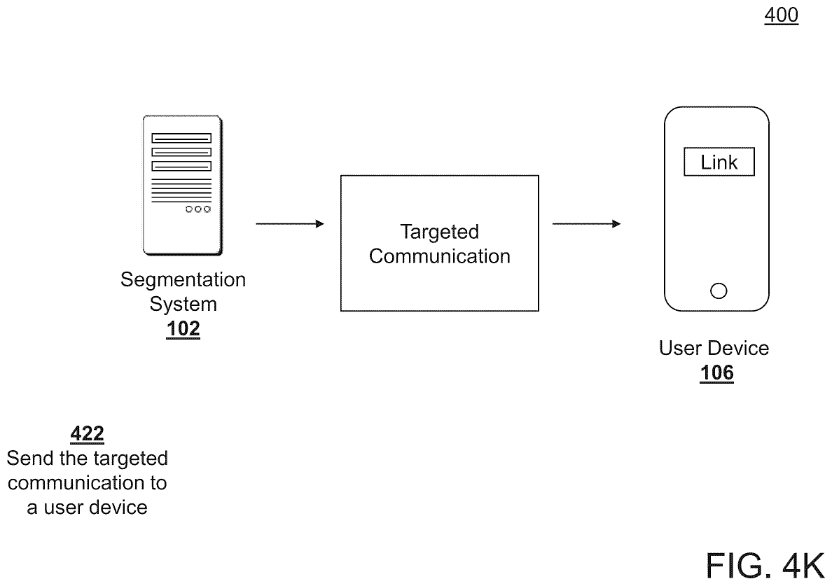

Referring now to FIGS. 4A-4K, shown are diagrams of non-limiting embodiments or aspects of an implementation 400 of a process (e.g., process 300) for segmenting users using a machine learning model based on transaction data. As shown in FIGS. 4A-4K, implementation 400 may include segmentation system 102 (e.g., one or more devices of segmentation system 102) performing one or more steps of the process.

As shown in FIG. 4A, at step 402, segmentation system 102 may receive data for a first subset of users. For example, segmentation system 102 may receive survey data and/or historical transaction data for a first subset of users from database 104. In some non-limiting embodiments or aspects, the first subset of users may include one or more users. In some non-limiting embodiments or aspects, segmentation system 102 may receive survey data and/or historical transaction data for each user of the first subset of users. In some non-limiting embodiments or aspects, the survey data may include a plurality of questions. The plurality of questions may be subjective questions. For example, possible answers to the plurality of questions may range from “definitely disagree” to “definitely agree” having a plurality of possible answers to indicate the user's degree of agreement and/or disagreement. The possible answers to the plurality of questions may have a numerical component which indicates the degree to which the user agrees and/or disagrees with a particular question. Any other style of question/answer survey may be used. In some non-limiting embodiments or aspects, the survey data may include a plurality of responses to the plurality of questions.

In some non-limiting embodiments or aspects, the historical transaction data may include a plurality of transaction parameters. In some non-limiting embodiments or aspects, the plurality of transaction parameters may be associated with electronic payment transactions engaged in by a user of the first subset of users, as previously described. In some non-limiting embodiments or aspects, the historical transaction data may include a transaction type (e.g., ATM transaction, contactless transaction, eCommerce transaction, eWallet, etc.). In some non-limiting embodiments or aspects, the historical transaction data may include geographic data (e.g., a merchant city) and/or a merchant category code (MCC).

As shown in FIG. 4B, at step 404, segmentation system 102 may determine a plurality of characteristics (e.g., Characteristic 1, Characteristic 2, . . . , Characteristic Y) based on the plurality of responses to the plurality of questions (e.g., Response 1, Response 2, . . . , and Response X). A number of the plurality of characteristics may be higher or lower than a number of the plurality of responses to the plurality of questions. In some non-limiting embodiments or aspects, each of the plurality of responses may be associated with one or more characteristics of the plurality of characteristics. The plurality of characteristics and/or groups (described hereinafter) may represent subjective personas which can indicate a predicted behavior associated with users classified with the persona.

As shown in FIG. 4C, at step 406, segmentation system 102 may determine at least one characteristic for each user of the first subset of users. For example, segmentation system 102 may determine at least one characteristic (e.g., Characteristic 1, Characteristic 2, Characteristic 3, Characteristic, 4, Characteristic Y) for each user of the first subset of users (e.g., User 1₁, User 2₁, . . . , User X₁) based on a respective plurality of responses to the plurality of questions for each user of the first subset of users. In some non-limiting embodiments or aspects, a user may be associated with one or more characteristics of the plurality of characteristics (e.g., User 1₁ may be associated with Characteristic 1 and/or Characteristic 4, User 2₁ may be associated with Characteristic 4 and/or Characteristic Y, and User X₁ may be associated with Characteristic 2 and/or Characteristic 3).

In some non-limiting embodiments or aspects, segmentation system 102 may analyze the plurality of responses to the plurality of questions (e.g., Response 1, Response 2, . . . , Response X) for each user of the first subset of users (e.g., User 1₁, User 2₁, . . . , User X1) to determine the at least one characteristic for each user of the first subset of users.

As shown in FIG. 4D, at step 408, segmentation system 102 may segment each user of the first subset of users into at least one group. For example, segmentation system 102 may segment each user of the first subset of users into at least one group of the plurality of groups (e.g., Group A, Group B, Group C, . . . , Group G) based on the survey data.

In some non-limiting embodiments or aspects, segmentation system 102 may segment users from the first subset of users into the plurality of groups based on the plurality of characteristics. For example, segmentation system 102 may segment the first subset of users into the plurality of groups based on the plurality of characteristics, where each group of the plurality of groups is associated with at least one characteristic of the plurality of characteristics (e.g., Group A is associated with Characteristic 1, Group B is associated with Characteristic 2 and Characteristic 3, Group C is associated with Characteristic 4, Group G is associated with Characteristic Y). In some non-limiting embodiments or aspects, one group may be associated with one or more characteristics (e.g., Group B).

In some non-limiting embodiments or aspects, segmentation system 102 may segment each user of the first subset of users into at least one group of the plurality of groups based on the determined at least one characteristic for each user of the first subset of users. For example, User 1₁ is associated with Characteristic 1 and Characteristic 4, as seen in FIG. 4C. User 1₁ is then segmented into Group A (e.g., the group associated with Characteristic 1) and Group C (e.g., the group associated with Characteristic 4), as seen in FIG. 4D.

As shown in FIG. 4E, at step 410, segmentation system 102 may analyze the historical transaction data for the first subset of users against the survey data for the first subset of users to associate at least one transaction parameter (e.g., Parameter 1, Parameter 2, . . . , Parameter X) with each group of the plurality of groups (e.g., Groups A, B, C, D, E, F, and G).

For example, this analysis may be performed as shown in FIG. 4F, where at step 412, segmentation system 102 may input the historical transaction data for the first subset of users into a machine learning model. For example, segmentation system 102 may input the historical transaction data for the first subset of users into a machine learning model to analyze the historical transaction data for the first subset of users. In some non-limiting embodiments or aspects, the machine learning model in FIG. 4F may be the second machine learning model, as described herein. In some non-limiting embodiments or aspects, segmentation system 102 may automatically analyze the historical transaction data for the first subset of users against the survey data and/or the at least one characteristic (not shown) to associate at least one transaction parameter of the plurality of transaction parameters (e.g., Parameter 1, Parameter 2, . . . , Parameter X) with each group of the plurality of groups (e.g., Groups A, B, C, . . . , and G) using the second machine learning model. For example, segmentation system 102 may input the historical transaction data into the second machine learning model. An output of the second machine learning model may indicate an association between at least one transaction parameter of the plurality of transaction parameters and at least one group of the plurality of groups (e.g., Parameter 3 associated with Group A, Parameter 2 associated with Group B, Parameter X associated with Group C, and Parameter 1 associated with Group G, as seen in FIG. 4F). In some non-limiting embodiments or aspects, an output of the second machine learning model may be an indication that a parameter of the plurality of parameters is classified as belonging to a group of the plurality of groups. The associations between transaction parameters and groups may be based on correlations determined by the second machine learning model between at least one transaction parameter and survey data and/or at least one characteristic such that certain transaction parameters are associated with certain groups. In this way, transaction parameters may additionally or alternatively be used to group users.

As shown in FIG. 4G, at step 414, segmentation system 102 may receive data for a second subset of users. In some non-limiting embodiments or aspects, the data for the second subset of users may include historical transaction data. For example, segmentation system 102 may receive historical transaction data for the second subset of users from database 104. In some non-limiting embodiments or aspects, only historical transaction data may be received for the second subset of users, in which case, survey data may not be received for the second subset of users.

In some non-limiting embodiments or aspects, the second subset of users may not contain users from the first subset of users. In some non-limiting embodiments or aspects, the second subset of users may include one or more users. In some non-limiting embodiments or aspects, segmentation system 102 may receive historical transaction data for each user of the second subset of users.

As shown in FIG. 4H, at step 416, segmentation system 102 may input the historical transaction data for the second subset of users into a machine learning model. In some non-limiting embodiments or aspects, the machine learning model in FIG. 4H may be the first machine learning model, as described herein. In some non-limiting embodiments or aspects, the first machine learning model may be trained to perform a first task, wherein the first task includes segmenting each user of the second subset of users into at least one group based on inputting the historical transaction data for the second subset of users into the machine learning model and/or based on the association of the at least one transaction parameter of the plurality of transaction parameters with each group of the plurality of groups.

As shown in FIG. 4I, at step 418, segmentation system 102 may segment each user of the second subset of users into at least one group. For example, segmentation system 102 may, using a machine learning model, segment each user of the second subset of users (e.g., User 1₂, User 2₂, . . . , User Z₂) into at least one group of the plurality of groups (e.g., Groups A, B, C, . . . , and G) based on the historical transaction data for the second subset of users (e.g., Parameter 1, Parameter 2, Parameter 3, . . . , Parameter X) and without survey data for the second subset of users. In some non-limiting embodiments or aspects, the machine learning model shown in FIG. 4I is the first machine learning model, as described herein. In some non-limiting embodiments or aspects, the output of the first machine learning model may be an indication that a user of the second subset of users is classified as belonging to a group of the plurality of groups.

In some non-limiting embodiments or aspects, segmentation system 102 may segment the second subset of users using a clustering algorithm. For example, segmentation system 102 may segment the second subset of users, with the first machine learning model, using a k-means clustering algorithm (e.g., k-means clustering technique).

In some non-limiting embodiments or aspects, segmentation system 102 may evaluate the segmenting performed on the second subset of users by the first machine learning model. For example, segmentation system 102 may evaluate the segmenting performed by the first machine learning model by generating a silhouette coefficient for at least one group of the plurality of groups. In some non-limiting embodiments or aspects, segmentation system 102 may compare the silhouette coefficient to a threshold value. In some non-limiting embodiments or aspects, the threshold value may be predefined to ensure the group represents a cluster having sufficient similarity of all group members. In some non-limiting embodiments or aspects, in response to the silhouette coefficient not satisfying the threshold, segmentation system 102 may update the association of at least one transaction parameter of the plurality of transaction parameters with each group of the plurality of groups to associate at least one different transaction parameter with at least one group of the plurality of groups.

As shown in FIG. 4J, at step 420, segmentation system 102 may transmit a targeted communication to each user of the second subset of users in at least one group. In some non-limiting embodiments or aspects, segmentation system 102 may generate the targeted communication for each user of the second subset of users in the at least one group (e.g., User 1₂ and User 2₂ in Group A). In some non-limiting embodiments or aspects, the targeted communication may include at least a user-selectable link to at least one offer relevant to the at least one characteristic associated with the at least one group of the plurality of groups (e.g., user device of User 1₂ and user device of User 2₂ in Group A).

As shown in FIG. 4K, at step 422, segmentation system 102 may send the targeted communication to user device 106. For example, segmentation system 102 may send the targeted communication to a user device of the second subset of users in the at least one group. In some non-limiting embodiments or aspects, the targeted communication may be a message and/or an alert. In some non-limiting embodiments or aspects, the targeted communication may include a link to at least one offer relevant to the at least one characteristic associated with the at least one group of the plurality of groups. In some non-limiting embodiments or aspects, the targeted communication may be displayed on a user device via a GUI on the user device. For example, user device 106 may display data associated with the targeted communication via a GUI. In some non-limiting embodiments or aspects, the GUI many be an interactive GUI and include at least one selectable option. In some non-limiting embodiments or aspects, the interactive GUI may be updated based on a user selecting the at least one selectable option. For example, the user may select the at least one selectable option to accept the offer, which may comprise initiating an electronic payment transaction associated with the offer. The segmentation system may receive notification data that the targeted communication resulted in the acceptance of the offer, which data may be used as input to further improve the model.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A computer-implemented method comprising:
receiving survey data and historical transaction data for a first subset of users, wherein for each user of the first subset of users, the survey data comprises a plurality of questions and a plurality of responses to the plurality of questions, and the historical transaction data comprises a plurality of transaction parameters associated with electronic payment transactions engaged in by a user of the first subset of users;
based on the survey data, segmenting each user of the first subset of users into at least one group of a plurality of groups, wherein each group of the plurality of groups is associated with at least one characteristic;
analyzing the historical transaction data for the first subset of users against the survey data and/or the at least one characteristic to associate at least one transaction parameter of the plurality of transaction parameters with each group of the plurality of groups;
receiving data for a second subset of users, wherein the second subset of users does not contain users from the first subset of users, wherein the data comprises historical transaction data for the second subset of users;
based on the historical transaction data for the second subset of users, segmenting, with a first machine learning model, each user of the second subset of users into at least one group of the plurality of groups; and
based on at least one characteristic associated with the at least one group of the plurality of groups, automatically transmitting a targeted communication to each user of the second subset of users in the at least one group.

2. The method of claim 1, further comprising:
generating the first machine learning model, wherein generating the first machine learning model comprises training the first machine learning model to perform a first task, wherein the first task comprises segmenting each user of the second subset of users into at least one group of the plurality of groups based on inputting the historical transaction data for the second subset of users into the first machine learning model and based on the association of the at least one transaction parameter of the plurality of transaction parameters with each group of the plurality of groups.

3. The method of claim 1, further comprising:
determining a plurality of characteristics based on the plurality of responses to the plurality of questions; and
segmenting users from the first subset of users into the plurality of groups based on the plurality of characteristics, wherein each group of the plurality of groups is associated with at least one characteristic of the plurality of characteristics.

4. The method of claim 1, wherein segmenting each user of the first subset of users into at least one group of the plurality of groups comprises:
analyzing the plurality of responses to the plurality of questions for each user of the first subset of users;
determining at least one characteristic for each user of the first subset of users based on a respective plurality of responses to the plurality of questions for each user of the first subset of users; and
segmenting each user of the first subset of users into at least one group of the plurality of groups based on the determined at least one characteristic for each user of the first subset of users.

5. The method of claim 1, wherein analyzing the historical transaction data for the first subset of users against the survey data and/or the at least one characteristic to associate at least one transaction parameter of the plurality of transaction parameters with each group of the plurality of groups comprises:
automatically analyzing the historical transaction data for the first subset of users against the survey data and/or the at least one characteristic to associate at least one transaction parameter of the plurality of transaction parameters with each group of the plurality of groups using a second machine learning model.

6. The method of claim 1, wherein automatically transmitting the targeted communication to each user of the second subset of users in the at least one group comprises:
generating the targeted communication for each user of the second subset of users in the at least one group, the targeted communication comprising a user-selectable link to at least one offer relevant to the at least one characteristic associated with the at least one group of the plurality of groups; and
sending the targeted communication to a user device of each user of the second subset of users in the at least one group.

7. The method of claim 1, wherein survey data is not received for the second subset of users.

8. The method of claim 1, wherein the first machine learning model segments the second subset of users using a k-means clustering technique.

9. The method of claim 1, further comprising:
evaluating the segmenting performed by the first machine learning model by generating a silhouette coefficient for at least one group of the plurality of groups.

10. The method of claim 9, further comprising:
in response to the silhouette coefficient not satisfying a threshold, updating the association of at least one transaction parameter of the plurality of transaction parameters with each group of the plurality of groups to associate at least one different transaction parameter with at least one group of the plurality of groups.

11. A system comprising:
at least one processor programmed or configured to:
receive survey data and historical transaction data for a first subset of users, wherein for each user of the first subset of users, the survey data comprises a plurality of questions and a plurality of responses to the plurality of questions, and the historical transaction data comprises a plurality of transaction parameters associated with electronic payment transactions engaged in by a user of the first subset of users;
based on the survey data, segment each user of the first subset of users into at least one group of a plurality of groups, wherein each group of the plurality of groups is associated with at least one characteristic;
analyze the historical transaction data for the first subset of users against the survey data and/or the at least one characteristic to associate at least one transaction parameter of the plurality of transaction parameters with each group of the plurality of groups;
receive data for a second subset of users, wherein the second subset of users does not contain users from the first subset of users, wherein the data comprises historical transaction data for the second subset of users;
based on the historical transaction data for the second subset of users, segment, with a first machine learning model, each user of the second subset of users into at least one group of the plurality of groups; and
based on at least one characteristic associated with the at least one group of the plurality of groups, automatically transmit a targeted communication to each user of the second subset of users in the at least one group.

12. The system of claim 11, wherein the at least one processor is further programmed or configured to:
generate the first machine learning model, wherein when generating the first machine learning model, the at least one processor is programmed or configured to:
train the first machine learning model to perform a first task, wherein the first task comprises segmenting each user of the second subset of users into at least one group of the plurality of groups based on inputting the historical transaction data for the second subset of users into the first machine learning model and based on the association of the at least one transaction parameter of the plurality of transaction parameters with each group of the plurality of groups.

13. The system of claim 11, wherein the at least one processor is further programmed or configured to:
determine a plurality of characteristics based on the plurality of responses to the plurality of questions; and
segment users from the first subset of users into the plurality of groups based on the plurality of characteristics, wherein each group of the plurality of groups is associated with at least one characteristic of the plurality of characteristics.

14. The system of claim 11, wherein when segmenting each user of the first subset of users into at least one group of a plurality of groups, the at least one processor is programmed or configured to:
analyze the plurality of responses to the plurality of questions for each user of the first subset of users;
determine at least one characteristic for each user of the first subset of users based on a respective plurality of responses to the plurality of questions for each user of the first subset of users; and
segment each user of the first subset of users into at least one group of the plurality of groups based on the determined at least one characteristic for each user of the first subset of users.

15. The system of claim 11, wherein when analyzing the historical transaction data for the first subset of users against the survey data and/or the at least one characteristic to associate at least one transaction parameter of the plurality of transaction parameters with each group of the plurality of groups, the at least one processor is programmed or configured to:
automatically analyze the historical transaction data for the first subset of users against the survey data and/or the at least one characteristic to associate at least one transaction parameter of the plurality of transaction parameters with each group of the plurality of groups using a second machine learning model.

16. The system of claim 11, wherein when automatically transmitting a targeted communication to each user of the second subset of users in the at least one group, the at least one processor is programmed or configured to:
generate the targeted communication for each user of the second subset of users in the at least one group, the targeted communication comprising a user-selectable link to at least one offer relevant to the at least one characteristic associated with the at least one group of the plurality of groups; and
send the targeted communication to a user device of each user of the second subset of users in the at least one group.

17. The system of claim 11, wherein survey data is not received for the second subset of users.

18. The system of claim 11, wherein the first machine learning model segments the second subset of users using a k-means clustering technique.

19. The system of claim 11, wherein the at least one processor is further programmed or configured to:
evaluate the segmenting performed by the first machine learning model by generating a silhouette coefficient for at least one group of the plurality of groups; and
in response to the silhouette coefficient not satisfying a threshold, update the association of at least one transaction parameter of the plurality of transaction parameters with each group of the plurality of groups to associate at least one different transaction parameter with at least one group of the plurality of groups.

20. A computer program product comprising at least one non-transitory computer-readable medium including one or more instructions that, when executed by at least one processor, cause the at least one processor to:
receive survey data and historical transaction data for a first subset of users, wherein for each user of the first subset of users, the survey data comprises a plurality of questions and a plurality of responses to the plurality of questions, and the historical transaction data comprises a plurality of transaction parameters associated with electronic payment transactions engaged in by a user of the first subset of users;
based on the survey data, segment each user of the first subset of users into at least one group of a plurality of groups, wherein each group of the plurality of groups is associated with at least one characteristic;
analyze the historical transaction data for the first subset of users against the survey data and/or the at least one characteristic to associate at least one transaction parameter of the plurality of transaction parameters with each group of the plurality of groups;
receive data for a second subset of users, wherein the second subset of users does not contain users from the first subset of users, wherein the data comprises historical transaction data for the second subset of users;
based on the historical transaction data for the second subset of users, segment, with a machine learning model, each user of the second subset of users into at least one group of the plurality of groups; and
based on at least one characteristic associated with the at least one group of the plurality of groups, automatically transmit a targeted communication to each user of the second subset of users in the at least one group.
